(19) United States
(12) Patent Application Publication
(10) Pub. No.: US 2023/0034838 A1
(43) Pub. Date: Feb. 2, 2023

(54) VEHICLE STEERING DEVICE

(71) Applicant: NSK LTD., Tokyo (JP)

(72) Inventor: Kenji MORI, Kanagawa (JP)

(73) Assignee: NSK LTD., Tokyo (JP)

(21) Appl. No.: 17/783,771

(22) PCT Filed: Nov. 25, 2020
(86) PCT No.: PCT/JP2020/043887

§ 371 Date: Jun. 9, 2022

(30) Foreign Application Priority Data
Dec. 18, 2019 (JP) 2019-228558

(51) Int. Cl. B62D 6/00

(52) U.S. Cl. CPC B62D 6/008; B62D 6/002

(57) ABSTRACT

A first current command value of a turning motor is generated based on a target turning angle, and the turning motor is driven based on a second current command value obtained by restricting the first current command value with a current restriction value in accordance with the angular velocity of the turning motor. A first torque signal is generated based on a predetermined basic map in accordance with at least a vehicle speed and a steering angle of a vehicle, and a target steering torque is generated by adding, to the first torque signal, a second torque signal in accordance with the deviation between the first current command value and the second current command value.

### FIELD

The present invention relates to a vehicle steering device.

### BACKGROUND

A steer-by-wire (SBW) vehicle steering device in which a force feedback actuator (FFA; steering mechanism) through which a driver performs steering and a road. wheel actuator (RWA; rotation mechanism) configured to steer a vehicle are mechanically separated from each other is available as a vehicle steering device. Such a SBW vehicle steering device has a configuration in which the steering mechanism and the rotation mechanism are electrically connected to each other through a control unit (ECU; Electronic control unit) and control between the steering mechanism and the rotation mechanism is performed by electric signals.

For example, when the steering angle is abruptly changed due to abrupt steering of the driver in such a SBW vehicle steering device, the turning angle potentially becomes unable to follow the steering angle, and the turning angle in accordance with the steering angle is not obtained, which potentially provides discomfort to the driver. Thus, a technology of preventing the turning angle from becoming unable to follow the steering angle in the SBW vehicle steering device is disclosed (for example, Patent Literature 1).

### CITATION LIST

### Patent Literature

Patent Literature 1: Japanese Patent Application Laid-open. No. 2018-114845

### SUMMARY

### Technical Problem

In the above-described Patent Literature, steering reaction force is increased in accordance with an elapsed time when the duty ratio of a control signal corresponding to a voltage command value for a turning-side motor is at maximum (100%). Thus, with the technology disclosed in the above-described Patent Literature, it takes some time until necessary steering reaction force is actually obtained, and discomfort provided to the driver potentially cannot be sufficiently reduced.

The present invention is made in view of the above-described. problem and intended to provide a vehicle steering device that can increase the following capability of a steering angle and a turning angle and reduce discomfort provided to a driver.

### Solution to Problem

To achieve the above object, a vehicle steering device according to an embodiment of the present invention comprising: a reaction force motor configured. to apply steering reaction. force to a wheel; a turning motor configured to turn tires in accordance with steering of the wheel; and a control unit configured to control the reaction force motor and the turning motor, wherein. the control unit includes a target steering torque generation unit configured to generate target steering torque for the reaction force motor, a target turning angle generation unit configured to generate a target turning angle for the turning motor, a turning angle control unit configured to generate a first current command value of the turning motor based on the target turning angle and output a second current command value obtained by restricting the first current command value to a current restriction value in accordance with an angular velocity of the turning motor, and a current control unit configured to drive the turning motor based on the second current command value, and the target steering torque generation unit generates a first torque signal based on a predetermined basic map in accordance with at least a vehicle speed and a steering angle of a vehicle and Generates the target steering torque by adding, to the first torque signal, a second torque signal in accordance with a deviation between the first current command value and the second current command value.

With the above-described configuration, it is possible to perform real-time control in accordance with the deviation. between the first current command value and the second current command value, and thus it is possible to increase the following capability of the turning angle for the steering angle and reduce discomfort provided to a driver.

As a desirable embodiment of the vehicle steering device, it is preferable that the second torque signal is provided by an increasing function in accordance with the deviation between the first current command value and the second current command value.

Accordingly, it is possible to increase the steering reaction force as the deviation between the first current command value and the second current command value increases, thereby increasing the effect of reducing discomfort provided to the driver.

As a desirable embodiment of the vehicle steering device, the increasing function may be a linear function that passes through the origin of a two-dimensional graph having the deviation between the first current command value and the second current command value as a horizontal axis and having the second. torque signal as a vertical axis.

As a desirable embodiment of the vehicle steering device, the increasing function may be a cubic function that passes through the origin of a two-dimensional graph having the deviation between the first current command value and the second current command value as a horizontal axis and having the second torque signal as a vertical axis, and has no extreme value.

As a desirable embodiment of the vehicle steering device, the target steering torque generation unit may calculate the second torque signal by using the increasing function.

As a desirable embodiment of the vehicle steering device, the target steering torque generation unit may hold a characteristic of the increasing function as a map and calculate the second torque signal with reference to the map.

As a desirable embodiment of the vehicle steering device, it is preferable that the turning angle control unit outputs the current restriction value as the second current command value when the first current command value is larger than the current restriction value, and outputs the first current command value as the second current command value when the first current command value is equal to or smaller than the current restriction value.

Accordingly, it is possible to appropriately restrict motor current supplied to the turning motor.

As a desirable embodiment of the vehicle steering device, it is preferable that the current restriction value is set in accordance with a voltage value of a drive power source of the turning motor.

Accordingly, it is possible to appropriately restrict motor current supplied to the turning motor in accordance with the voltage value of the drive power source of the turning motor.

As a desirable embodiment of the vehicle steering device, it is preferable that the current restriction value corresponding to a predetermined angular velocity of the turning motor increases as the voltage value of the drive power source of the turning motor increases, and the current restriction value decreases as the voltage value of the drive power source of the turning motor decreases.

Accordingly, it is possible to restrict motor current supplied to the turning motor in accordance with decrease of the voltage value due to aging of the drive power source of the turning motor.

As a desirable embodiment of the vehicle steering device, it is preferable that a change amount of the current restriction value corresponding to a predetermined angular velocity of the turning motor is proportional to a change amount of the voltage value of the drive power source of the turning motor.

Accordingly, it is possible to appropriately restrict motor current supplied to the turning motor in. accordance with decrease of the voltage value due to aging of the drive power source of the turning motor.

### Advantageous Effects of Invention

According to the present invention, it is possible to provide a vehicle steering device that can increase the following capability of a steering angle and a turning angle and reduce discomfort provided to a driver.

### BRIEF DESCRIPTION OF DRAWINGS

FIG. 1 is a diagram illustrating the entire configuration of a steer-by-wire vehicle steering device.

FIG. 2 is a schematic diagram illustrating a hardware configuration of a control unit configured to control a SBW system.

FIG. 3 is a diagram illustrating an exemplary internal block configuration of the control unit according to a first embodiment.

FIG. 4 is a block diagram illustrating an exemplary configuration of a target steering torque generation unit according to the first embodiment.

FIG. 5 is a diagram illustrating exemplary characteristics of a basic map held by a basic map unit.

FIG. 6 is a diagram. illustrating exemplary characteristics of a damper gain. map held by a damper gain map unit.

FIG. 7 is a diagram. illustrating exemplary characteristics of a hysteresis correction unit.

FIG. 8 is a diagram illustrating exemplary characteristics of a turning motor output characteristic correction unit according to the first embodiment.

FIG. 9 is a block diagram illustrating an exemplary configuration of a twist angle control unit.

FIG. 10 is a block diagram illustrating an exemplary configuration of a target turning angle generation unit.

FIG. 11 is a block diagram illustrating an exemplary configuration of a turning angle control unit according to the first embodiment.

FIG. 12 is a diagram illustrating an exemplary current command value restriction characteristics according to the first embodiment.

FIG. 13 is a flowchart illustrating exemplary output restriction processing at an output restriction unit.

FIG. 14 is a diagram illustrating exemplary characteristics of the turning motor output characteristic correction unit according to a second embodiment.

FIG. 15 is a block diagram illustrating an exemplary configuration of the turning angle control unit according to a third embodiment.

FIG. 16 is a diagram illustrating an exemplary current command value restriction characteristic according to the third embodiment.

### DESCRIPTION OF EMBODIMENTS

Modes for carrying out the invention (hereinafter referred to as embodiments) will be described below in detail with reference to the accompanying drawings. Note that, the present invention is not limited by the following embodiments. In addition, components in the embodiments described. below include their equivalents such as those that could be easily thought of by the skilled person in the art and those identical in effect. Moreover, components disclosed in the embodiments described below may be combined as appropriate.

### First Embodiment

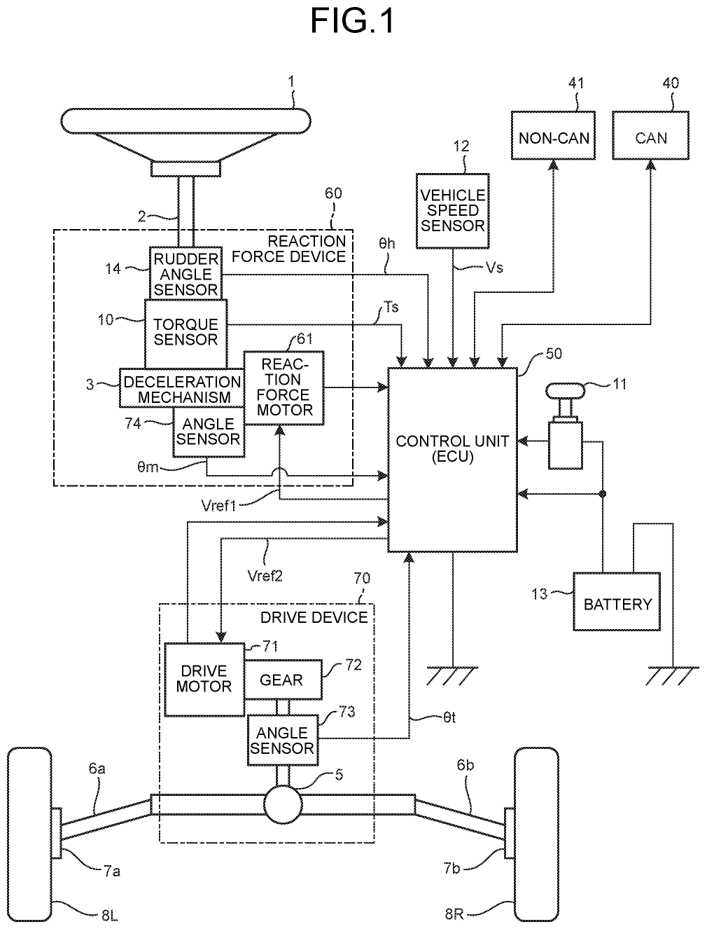

FIG. 1 is a diagram. illustrating the entire configuration of a steer-by-wire vehicle steering device. The steer-by-wire (SBW) vehicle steering device (hereinafter also referred to as an “SBW system”) illustrated in FIG. 1 is a system configured to transfer, by an electric signal, an operation of a wheel 1 to a rotation mechanism including steering wheels 8L and 8R. As illustrated in FIG. 1, the SBW system includes a reaction force device 60 and a drive device 70, and a control unit (ECU) 50 controls the devices.

The reaction force device 60 includes a torque sensor 10 configured to detect steering torque Ts of the wheel 1, a rudder angle sensor 14 configured to detect a steering angle θh, a deceleration mechanism 3, an angle sensor 74, and a reaction force motor 61. These components are provided to a column shaft 2 of the wheel 1.

The reaction force device 60 performs detection of the steering angle θh at the rudder angle sensor 14 and simultaneously transfers, to the driver as reaction force torque, the motion state of a vehicle conveyed from the steering wheels 8L and 8R. The reaction force torque is generated by the reaction force motor 61. The torque sensor 10 detects the steering torque Ts. In addition, the angle sensor 74 detects a motor angle θm of the reaction force motor 61.

The drive device 70 includes a turning motor 71, a gear 72, and an angle sensor 73. Drive power generated by the turning motor 71 is coupled. to the steering wheels 8L or 8R through. the gear 72, a pinion rack mechanism 5, and tie rods 6a and 6b and further through hub units 7a and 7b.

The drive device 70 drives the turning motor 71 in accordance with steering of the wheel. 1 by the driver, applies the drive power thereof to the pinion rack mechanism 5 through. the gear 72, and turns the steering wheels 8L and 8R through the tie rods 6a and 6b. The angle sensor 73 is disposed near the pinion rack mechanism 5 and detects a turning angle θt of the steering wheels 8L and 8R. To cooperatively control the reaction force device 60 and the drive device 70, the ECU 50 generates, based on a vehicle speed Vs from a vehicle speed sensor 12 and other information. in addition to information such as the steering angle θh and the turning angle θt output from both the devices, a voltage control command value Vref1for driving and controlling the reaction. force motor 61 and a voltage control command value Vref2 for driving and controlling the turning motor 71.

The angle sensor 73 may have an aspect of detecting the angle of the turning motor 71. In this case, an aspect may be employed in which a value detected by the angle sensor 73 is converted into the turning angle θt and used for control at a later stage.

Electric power is supplied from a battery 13 to the control unit (ECU) 50, and an ignition key signal is input to the control unit 50 through an ignition key 11. The control unit 50 performs calculation of a current command value based on the steering torque Ts detected by the torque sensor 10, the vehicle speed Vs detected by the vehicle speed sensor 12, and the like and controls current supplied to the reaction force motor 61 and the turning motor 71.

The control unit 50 is connected to an on-board network such as a controller area network (CAN) 40 through which various kinds of information of the vehicle are transmitted and received. In addition, a control unit 50 is connectable to a non-CAN 41 configured to transmit and receive communication other than the CAN 40, analog and digital signals, radio wave, and the like.

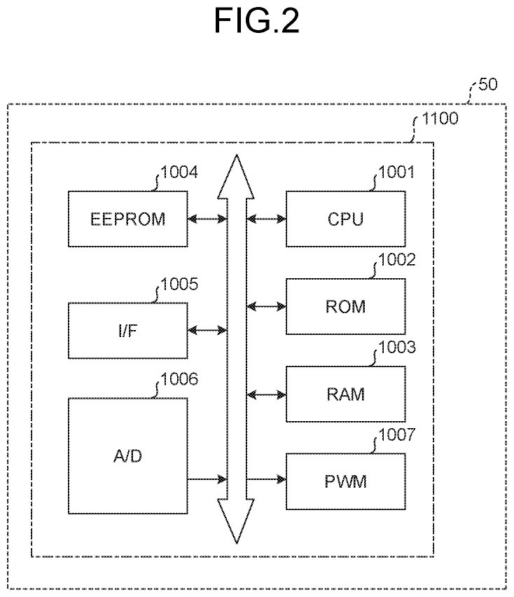

The control unit 50 is mainly configured as a CPU (including an MCU and an MPU). FIG. 2 is a schematic diagram illustrating a hardware configuration of the control unit configured to control the SBW system.

A control computer 1100 configured as the control unit 50 includes a central processing unit (CPU) 1001, a read only memory (ROM) 1002, a random. access memory (RAM) 1003, an electrically erasable programmable RUM (EEPRCM) 1004, an interface (I/F) 1005, an analog/digital (A/D) converter 1006, and a pulse width modulation (PWM) controller 1007, and these components are connected to a bus.

The CPU 1001 is a processing device configured to execute a computer program for control (hereinafter referred to as a control program) of the SBW system and control the SBW system.

The ROM 1002 stores a control program for controlling the SBW system. In addition, the RAM 1003 is used as a work memory for operating the control program. The EEPROM 1004 stores, for example, control data input to and output from the control program. The control data is used on the control program loaded onto the PAM 1003 after a control unit 30 is powered on, and is overwritten to the EEPROM 1004 at a predetermined timing.

The RCM 1002, the RAM 1003, the EEPROM 1004, and the like are storage devices configured to store information. and are storage devices (primary storage devices) directly accessible from the CPU 1001.

The A/D converter 1006 receives, for example, signals of the steering torque Ts and the steering angle θh and converts the signals into digital signals.

The interface 1005 is connected to the CAN 40. The interface 1005 receives a signal (vehicle speed pulse) of a vehicle speed V from the vehicle speed sensor 12.

The PWM controller 1007 outputs a PWM control signal of each UVW phase based on a current command value to the reaction force motor 61 and the turning motor 71.

The configuration of the first embodiment in which the present disclosure is applied to such a SBW system will be described below.

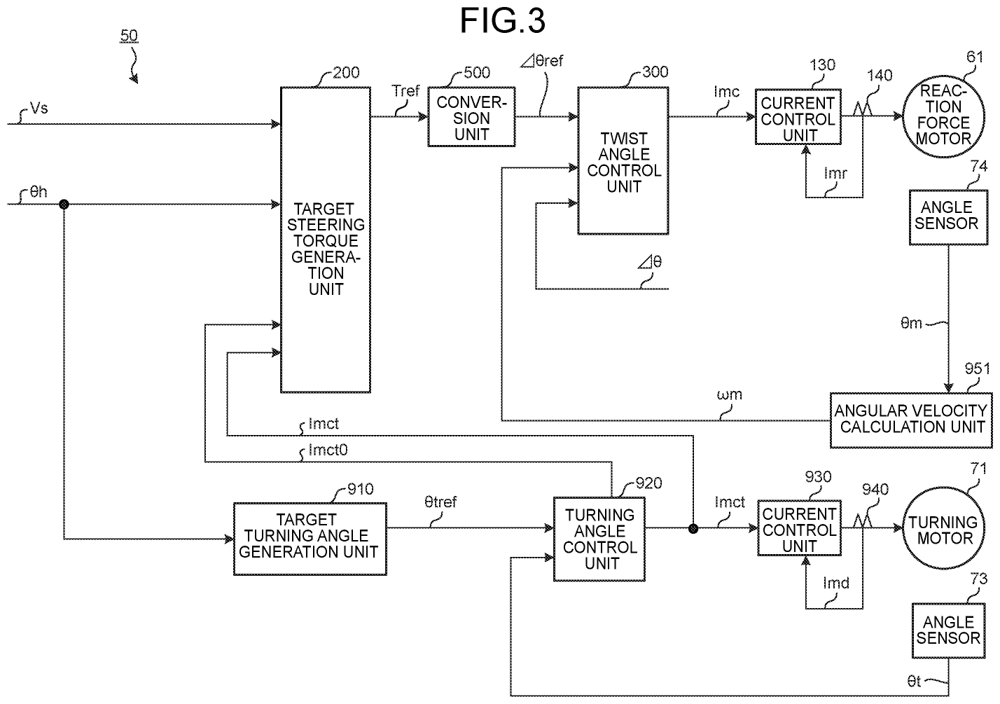

FIG. 3 is a diagram. illustrating an exemplary internal block configuration of the control unit according to the first embodiment. In. the present embodiment, control (hereinafter referred to as “twist angle control”) of a twist angle Δθand control (hereinafter referred to as “turning angle control”) of the turning angle θt are performed, the reaction force device 60 is controlled by the twist angle control, and the drive device 70 is controlled by the turning angle control. Note that, the drive device 70 may be controlled by another control method.

The control unit 50 includes, as an internal block configuration, a target steering torque generation unit 200, a twist angle control unit 300, a conversion unit 500, a target turning angle generation unit 910, and a turning angle control unit 920.

The target steering torque generation unit 200 generates a target steering torque Tref as a target. value of steering torque of the reaction. force device 60 in the present disclosure. The conversion unit 500 converts the target steering torque Tref into a target twist angle Δθref. The twist angle control unit 300 generates a motor current command value Imc as a control target value of current supplied to the reaction. force motor 61.

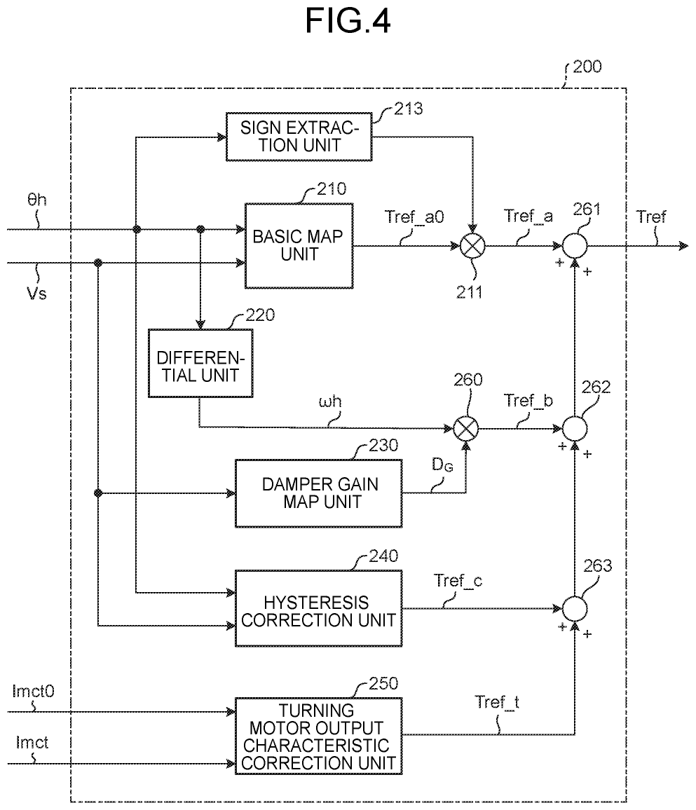

First in the following description, the target steering torque generation unit 200 according to the present embodiment will be described below with reference to FIG. 4.

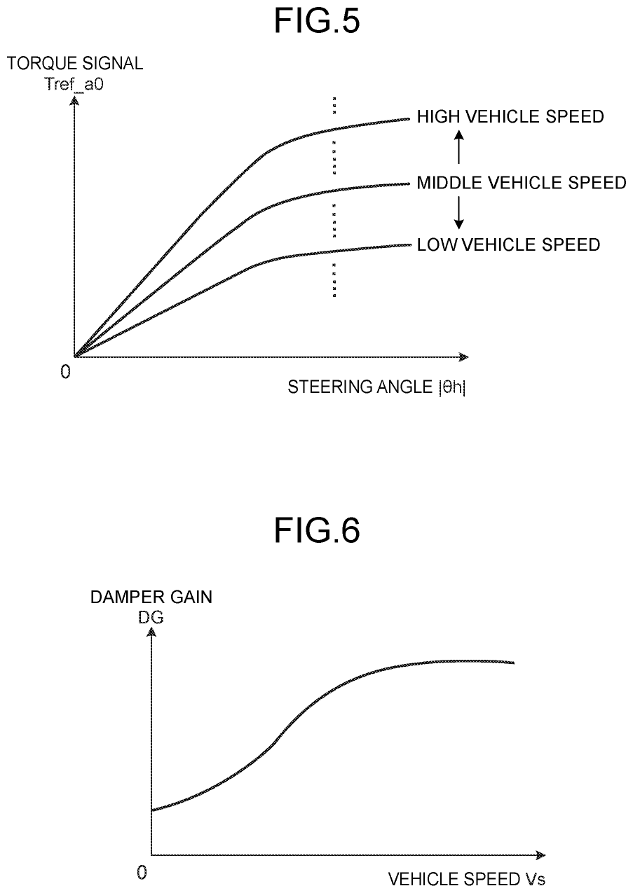

FIG. 4 is a block diagram. illustrating an exemplary configuration of the target steering torque generation unit according to the first embodiment. As illustrated in FIG. 4, the target steering torque generation unit 200 according to the present embodiment includes a basic map unit 210, a multiplication unit 211, a differential unit 220, a damper gain map unit 230, a hysteresis correction unit 240, a turning motor output characteristic correction unit 250, a multiplication unit 260, and addition units 261, 262, and 263. FIG. 5 is a diagram illustrating exemplary characteristics of a basic map held by the basic map unit FIG. 6 is a diagram illustrating exemplary characteristics of a damper gain map held by the damper gain map unit.

The steering angle θh and the vehicle speed Vs are input to the basic map unit 210. The basic map unit 210 outputs a torque signal Tref_a0 having the vehicle speed Vs as a parameter by using the basic map illustrated in FIG. 5. Specifically, the basic map unit 210 outputs the torque signal Tref_a0 in accordance with the vehicle speed Vs.

As illustrated in FIG. 5, the torque signal Tref_a0 has such a characteristic that the torque signal Tref_a0 increases along a curve having a change rate that gradually decreases as the magnitude (absolute value) |θh| of the steering angle θh increases. In addition, the torque signal Tref_a0 has such a characteristic that the torque signal Tref_a0 increases as the vehicle speed Vs increases. Note that, although a map in accordance with the magnitude |θh| of the steering angle θh is configured in FIG. 5, a map in accordance with the positive and negative values of the steering angle θh may be configured. In this case, the value of the torque signal Tref_a0 can be positive and negative, and sign calculation to be described later is unnecessary. The following description will be made on an aspect of outputting the torque signal Tref_a0 that is a positive value .in accordance with the magnitude HMI of the steering angle θh illustrated. in FIG. 5.

Back in FIG. 4, a sign. extraction unit 213 extracts the sign of the steering angle θh. Specifically, for example, the value of the steering angle θh. is divided by the absolute value of the steering angle θh. Accordingly, the sign extraction. unit 213 outputs “1” when the sign of the steering angle θh is “+”, or outputs “−1” when the sign of the steering angle θh is “−”. Specifically, the sign extraction unit 213 generates, for example, a sign function (sign(θh)) of the steering angle θh.

The multiplication unit 211 multiplies the torque signal Tref_a0 output from the basic map unit 210 by “1” or “−1” output from the sign extraction unit 213, and outputs a result of the multiplication as a torque signal Tref_a to the addition unit 261. Specifically, the multiplication unit 211 multiplies the torque signal Tref_a0 output from the basic map unit 210 by, for example, the sign function. (sign θh)) of the steering angle θh, which is generated by the sign extraction unit 213, and outputs a result of the multiplication as the torque signal Tref_a to the addition unit 261.

The torque signal Tref_a in the present embodiment corresponds to a “first torque signal” of the present disclosure.

The steering angle θh is input to the differential unit 220. The differential unit 220 calculates a rudder angular velocity ωh that is angular velocity information by differentiating the steering angle θh. The differential unit 220 outputs the calculated rudder angular velocity ωh to the multiplication unit 260.

The vehicle speed Vs is input to the damper gain map unit 230. The damper gain map unit 230 outputs a damper gain D_{G} in accordance with the vehicle speed Vs by using a vehicle speed sensitive damper gain map illustrated in FIG. 6.

As illustrated in FIG. 6, the damper gain. D_{G} has such a characteristic that the damper gain D_{G} gradually increases as the vehicle speed Vs increases. The damper gain D_{G} may have an aspect of being variable in accordance with the steering angle θh.

Back in FIG. 4, the multiplication unit 260 multiplies the rudder angular velocity ωh output from the differential unit 220 by the damper gain D_{G} output from the damper gain map unit 230, and outputs a result of the multiplication as a torque signal Tref_b to the addition unit 262.

The hysteresis correction unit 240 calculates a torque signal Tref_c based on the steering angle θh and a steering state signal STs by using Expressions (1) and (2) below. The steering state signal STs, description of which is omitted here, is a state signal indicating a result of determination of whether the steering direction is right or left based on the sign of a motor angular velocity ωm. Note that, in Expressions (1) and (2) below, x represents the steering angle θh, and y_{R}=Tref_c and y_{L}=Tref_c represent the torque signal (fourth torque signal) Tref_c. In addition, a coefficient “a” is a value larger than one, and a coefficient “c” is a value larger than zero. A coefficient Ahys indicates the output width of a hysteresis characteristic, and the coefficient “c” indicates the roundness of the hysteresis characteristic.

y_{R}=Ahys{1−a^{-c(x-b)}} (1)

y_{L}=Ahys{1−a^{c(x-b′)}} (2)

In a case of right steering, the torque signal (fourth torque signal) Tref_c (y_{R}) is calculated by using Expression (1) above. In a case of left steering, the torque signal (fourth torque signal) Tref_c (y_{L}) is calculated by using Expression (2) above. Note that, when switching is made from right steering to left steering or when switching is made from left steering to right steering, a coefficient “b” or “b′” indicated in Expression (3) or (4) below is substituted into Expressions (1) and (2) above after steering switching based on the values of final coordinates (x₁, y₁) that are the previous values of the steering angle θh and the torque signal Tref_c. Accordingly, continuity through steering switching is maintained.

b=x₁+(1/c)logₐ{1−(y₁/Ahys)} (3)

b′=x₁−(1/c)logₐ{1−(y₁/Ahys)} (4)

Expressions (3) and (4) above can be derived by substituting x₁ into x and substituting y₁ into y_{R} and y_{L} in Expressions (1) and (2) above.

For example, when Napierian logarithm e is used as the coefficient “a”, Expressions (1), (2), (3), and (4) above can be expressed as Expressions (5), (6), (7), and (8) below, respectively.

y_{R}=Ahys[1−exp{−c(x−b)}] (5)

y_{L}=−Ahys[{1−exp{c(x−b′)}] (6)

b=x₁+(1/c)logₑ{1−(y₁/Ahys)} (7)

b′=x₁−(1/c)logₑ{1−(y₁/Ahys)} (8)

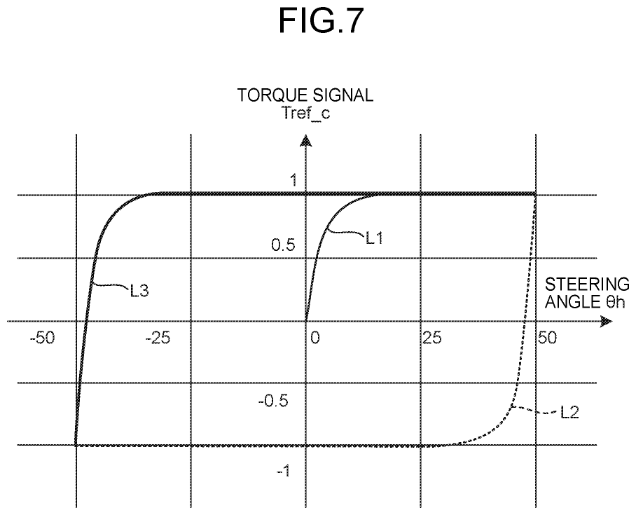

FIG. 7 is a diagram illustrating exemplary characteristics of the hysteresis correction unit. The example illustrated in FIG. 7 indicates an exemplary characteristic of the torque signal Tref_c subjected to hysteresis correction when Ahys−1[Nm] and c=0.3 are set in Expressions (7) and (8) above and steering is performed from 0 [deg] to ±50 [deg] or −50 [deg]. As illustrated in FIG. 7, the torque signal Tref_c output from the hysteresis correction unit 240 has a hysteresis characteristic such as the origin at zero →L1 (thin line) →L2 (dashed line) →L3 (bold line).

Note that, the coefficient Ahys, which indicates the output width of the hysteresis characteristic, and the coefficient c, which indicates the roundness thereof may be variable in accordance with one or both of the vehicle speed Vs and the steering angle θh.

In addition, the rudder angular velocity ωh is obtained through the differential calculation on the steering angle θh but low-pass filter (LPF) processing is employed as appropriate to reduce influence of noise in a higher range. In addition, the differential calculation and the LPL processing may be performed with a high-pass filter (HPF) and a gain. Moreover, the rudder angular velocity ωh may be calculated by performing the differential calculation and the LPF processing not on the steering angle θh but on a wheel angle θ1 detected by the upper angle sensor or a column angle θ2 detected by the lower angle sensor. The motor angular velocity ωm may be used as the angular velocity information in place of the rudder angular velocity ωh, and in this case, the differential unit 220 is not needed.

A motor current command value (first current command value) Imct0 before output restriction and a motor current command value (second current command value) Imct after output restriction, which are output from the turning angle control unit 920 to be described later are input to the turning motor output characteristic correction unit 250.

In the present embodiment, the turning motor output characteristic correction unit 250 calculates a torque signal Tref by using an increasing function indicated. by Expression (9) below based on the motor current command value (first current command value) Imct0 and the motor current command value (second current command value) Imct. Note that, G in Expression (9) below is a coefficient that indicates a predetermined gain.

Tref_t=G-×(Imct0−Imct) (9)

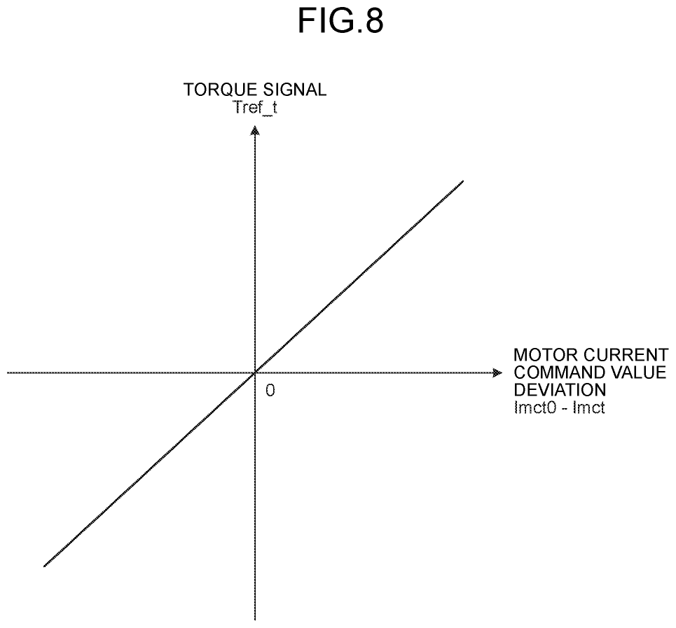

FIG. 8 is a diagram illustrating exemplary characteristics of the turning motor output characteristic correction unit according to the first embodiment. The exemplary characteristics illustrated in FIG. 8 are expressed as a two-dimensional graph of the increasing function indicated by Expression (9) above. In FIG. 8, the horizontal axis represents a motor current command value deviation Imct0-Imct, and the vertical axis represents the torque signal Tref_t. As illustrated in FIG. 8, the increasing function indicated by Expression (9) above is a linear function that passes through the origin ((Imct0-Imct), Tref_t)=(0, 0).

The turning motor output characteristic correction unit 250 may hold the exemplary characteristics illustrated in FIG. 8 as a map and calculate the torque signal Tref_t in a map referring manner.

For example, in a case of right steering, the torque signal Tref_t has a positive value when the deviation (Imct0-Imct) between the motor current command value (first current command value) Imct0 and the motor current command value (second current command value) Imct has a positive value.

In a case of left steering, the torque signal Tref_t has a negative value when. the deviation (Imct0-Imct) between the motor current command value (first current command value) Imct0 and the motor current command value (second current command value) Imct has a negative value.

The value of the torque signal Tref_t is “0” when the deviation (Imct0-Imct) between the motor current command value (first current command value) Imct0 and the motor current command value (second current command value) Imct is “0”, in other words, no output restriction is provided by the turning motor output characteristic correction unit 250.

The torque signal Tref_t in the present embodiment corresponds to a “second torque signal” in the present disclosure.

The torque signals Tref_a, Tref_b, Tref_c, and Tref_t obtained as described above are added at the addition units 261, 262, and 263 and output as the target steering torque Tref.

In the twist angle control, such control that the twist angle Δθ follows the target twist angle Δθref calculated through the target steering torque generation unit 200 and the conversion unit 500 by using the steering angle θh and the like is performed. The motor angle θm of the reaction force motor 61 is detected by the angle sensor 74, and a motor angular velocity corn is calculated by differentiating the motor angle θm at an angular velocity calculation unit 951. The turning angle θt of the turning motor 71 is detected by the angle sensor 73. In addition, a current control unit 130 performs current control by driving the reacton force motor 61 based on the motor current command value Imc output from the twist angle control unit 300 and a current value liar of the reacton force motor 61 detected by a motor current detector 140.

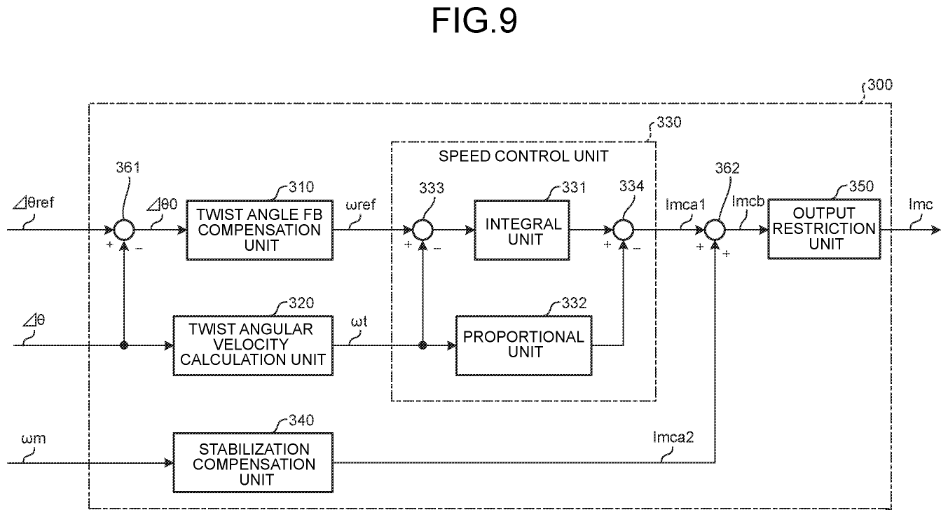

The twist angle control unit 300 will be described below with reference to FIG. 9.

FIG. 9 is a block diagram. illustrating an exemplary configuration of the twist angle control unit. The twist angle control unit 300 calculates the motor current command value Imc based on the target twist angle Δθref, the twist angle Δθ, and the motor angular velocity ωm. The twist angle control unit 300 includes a twist angle feedback (FB) compensation unit 310, a twist angular velocity calculation unit 320, a speed control unit 330, a stabilization compensation unit 340, an output restriction unit 350, a subtraction unit 361, and an addition unit 362.

The target twist angle Δθref output from the conversion unit 500 is input to the subtraction unit 361 through addition. The twist angle Δθ is input to the subtraction unit 361 through subtraction and also input to the twist angular velocity calculation unit 320. The motor angular velocity ωm is input to the stabilization compensation unit 340.

The twist angle FB compensation unit 310 multiplies a deviation Δθ0 between. the target twist. angle Δθref and the twist angle Δθ, which is calculated at the subtraction unit 361, by a compensation value CFB (transfer function) and outputs a target twist angular velocity ωref with which the twist angle Δθ follows the target twist angle Δθref. The compensation. value CFB may be a simple gain Kpp, or a typically used compensation value such as a PI control compensation value.

The target twist angular velocity ωref is input to the speed control unit 330. With the twist angle FB compensation unit 310 and the speed control unit 330, it is possible to cause the twist angle AO to follow the target twist angle Δθref, thereby achieving desired steering torque.

The twist angular velocity calculation unit 320 calculates a twist angular velocity wt. by performing differential arithmetic processing on the twist angle Δθ. The twist angular velocity ωt is output to the speed control unit 330. The twist angular velocity calculation unit 320 may perform, as differential calculation, pseudo differentiation with a HPF and a gain. In addition, the twist angular velocity calculation unit 320 may calculate the twist angular velocity ωt by another means or by using something other than the twist angle Δθ and may output the calculated twist angular velocity ωt to the speed control unit 330.

The speed control unit 330 calculates, by I-P control (proportional processing PI control), a motor current command value Imca1 with which the twist angular velocity ωt follows the target twist angular velocity ωref.

A subtraction unit 333 calculates a difference (ωref-ωt) between the target twist angular velocity ωref and the twist angular velocity ωt. An integral unit 331 integrates the difference (ωref-ωt) between the target twist angular velocity ωref and the twist angular velocity ωt, and inputs a result of the integration to a subtraction unit 334 through addition.

The twist angular velocity ωt is also output to a proportional unit 332. The proportional unit 332 performs proportional processing with a gain Kvp on the twist angular velocity ωt and inputs a result of the proportional processing to the subtraction unit 334 through subtraction. A result of the subtraction at the subtraction unit 334 is output as the motor current command value Imca1. Note that, the speed. control unit 330 may calculate the motor current command value Imca1 not by I-P control but by a typically used control method such as PI control, P (proportional) control, PID (proportional-integral-differential) control, PI-D control (differential processing PID control), model matching control, or model reference control.

The stabilization compensation unit 340 has a compensation value Cs (transfer function) and calculates a motor current command value Imca2 from the motor angular velocity ωm. When gains of the twist angle FB compensation unit 310 and the speed control unit 330 are increased to improve the following capability and the disturbance characteristic, a controlled oscillation phenomenon occurs in a higher range. To avoid this, the transfer function (Cs) that is necessary for stabilization of the motor angular velocity ωm is set to the stabilization compensation unit 340. Accordingly, stabilization of the entire reaction force device control system can be achieved.

The addition unit 362 adds the motor current command value Imca1 from the speed control unit 330 and the motor current command value Imca2 from the stabilization compensation unit 340, and outputs a result of the addition as a motor current command value Imcb.

The upper and lower limit values of the motor current command value Imcb are set to the output restriction unit 350 in advance. The output restriction unit 350 outputs the motor current command value Imc with restriction on the upper and lower limit values of the motor current command value Imcb.

Note that, the configuration of the twist angle control unit 300 in the present embodiment is exemplary and may be different from the configuration illustrated in FIG. 9. For example, the twist angle control unit 300 need not necessarily include the stabilization compensation unit 340.

In the turning angle control, a target turning angle θtref is generated at a target turning angle generation unit 910 based on the steering angle θh. The target turning angle θtref together with the turning angle θt is input to a turning angle control unit 920, and a motor current command value Imct with which the turning angle θt is equal to the target turning angle θtref is calculated at the turning angle control unit 920. Then, with configurations and operations same as those of the current control unit 130, a current control unit 930 performs current control by driving the turning motor 71 based on the motor current command value Imct and a current value Imd of the turning motor 71 detected by a motor current detector 940.

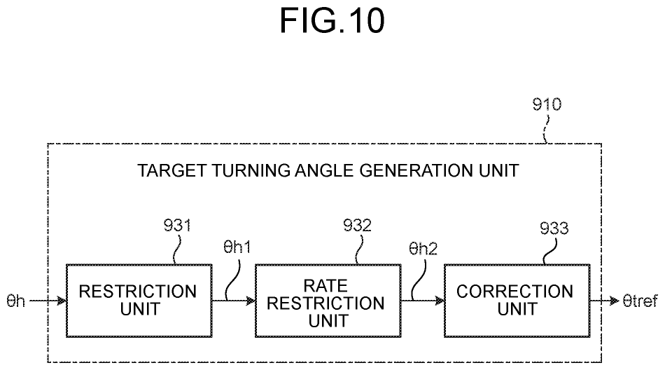

The target turning angle generation unit 910 will be described below with reference to FIG. 10.

FIG. 10 is a block diagram illustrating an exemplary configuration of the target turning angle generation unit. The target turning angle generation unit 910 includes a restriction unit 931, a rate restriction unit 932, and a correction unit 933.

The restriction unit 931 outputs a steering angle θh1 with restriction on the upper and lower limit values of the steering angle θh. Similarly to the output restriction unit 350 in the twist angle control unit 300 illustrated in FIG. 9, the upper and lower limit values of the steering angle θh are set in advance and restricted.

To avoid abrupt change of the steering angle, the rate restriction unit 932 provides restriction by setting a restriction value for the change amount of the steering angle θh1 and outputs the steering angle θh2. For example, the change amount is set to be the difference from the steering angle θh1 at the previous sample. When the absolute value of the change amount is larger than a predetermined value (restriction value), the steering angle θh1 is increased or decreased so that the absolute value of the change amount becomes equal to the restriction value, and the increased or decreased steering angle θh1 is output as the steering angle θh2. When the absolute value of the change amount is equal to or smaller than the restriction value, the steering angle θh1 is directly output as the steering angle θh1. Note that restriction may be provided by setting the upper and lower limit values of the change amount instead of setting the restriction value for the absolute value of the change amount, or restriction may be provided on a change rate or a difference rate in place of the change amount.

The correction unit 933 corrects the steering angle θh2 and outputs the target turning angle θtref.

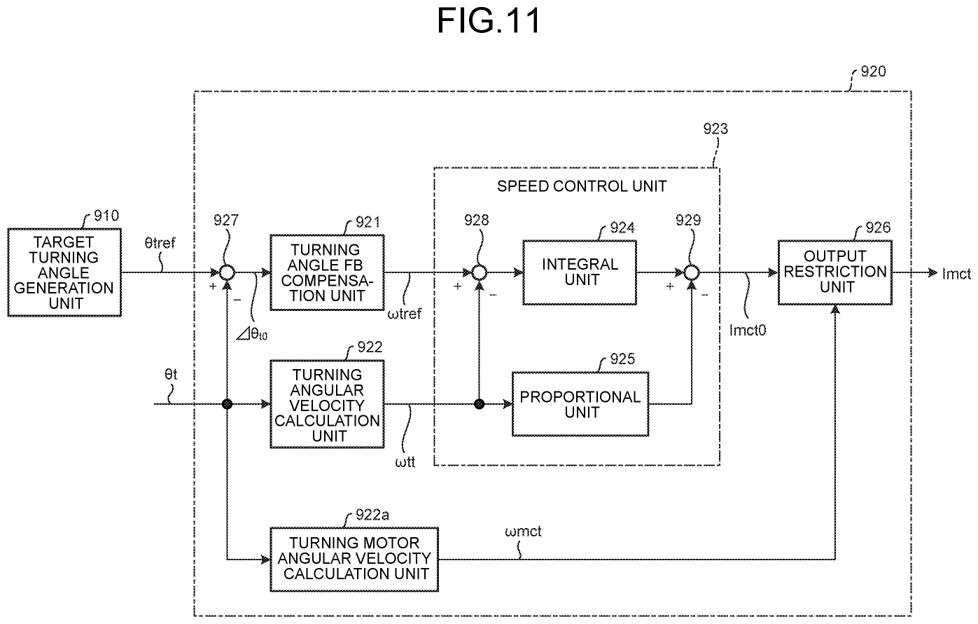

The turning angle control unit 920 will be described below with reference to FIG. 11.

FIG. 11 is a block diagram illustrating an exemplary configuration of the turning angle control unit according to the first embodiment. The turning angle control unit 920 calculates the motor current command value Imct based on the target turning angle θtref and the turning angle θt of the steering wheels 8L, and 8R. The turning angle control unit 920 includes a turning angle feedback (FB) compensation unit 921, a turning angular velocity calculation unit 922, a turning motor angular velocity calculation unit 922a, a speed control unit 923, an output restrict on unit 926, and a subtraction unit 927.

The target turning angle θtref output from the target turning angle generation unit 910 is input to the subtraction unit 927 through addition. The turning angle θt is input to a subtraction unit 927 through subtraction and also input to the turning angular velocity calculation unit 922.

The turning angle FB compensation unit 921 multiplies a deviation Δθt0 between a target turning angular velocity ωtref and the turning angle θt, which is calculated at the subtraction unit 927, by the compensation value CFB (transfer function), and outputs the target turning angular velocity ωtref with which the turning angle θt follows the target turning angle θtref. The compensation value CFB may be a simple gain Kpp, or a typically used compensation value such as a PI control compensation value.

The target turning angular velocity ωtref is input to the speed control unit 923. With the turning angle FB compensation unit 921 and the speed control unit 923, it is possible to cause the target turning angle θtref to follow the turning angle θt, thereby achieving desired torque.

The turning angular velocity calculation unit 922 calculates a turning angular velocity ωtt by performing differential arithmetic processing on the turning angle θt. The turning angular velocity ωtt is output to the speed control unit 923.

The turning motor angular velocity calculation unit 922a converts the turning angle θt into a turning motor angle and calculates a turning motor angular velocity 107 mct by performing differential arithmetic processing on the turning motor angle. The turning motor angular velocity ωmct is output to the output restriction unit 926. The turning motor angular velocity calculation unit 922a may calculate the turning motor angular velocity ωmct by performing differential arithmetic processing on a value detected by an angle sensor configured to detect the turning motor angle.

The speed control unit 923 calculates, by I-P control (proportional processing PI control), a motor current command value (first current command value) Imct0 with which the turning angular velocity ωtt follows the target turning angular velocity ωtref. Note that, the speed control unit 923 may calculate the motor current command value (first current command value) Imct0 not by I-P control but by a typically used control method such as PI control, P (proportional) control, PID (proportional-integral-differential) control, PI-D control (differential processing PID control), model matching control, or model reference control.

A subtraction unit 928 calculates a difference (ωtref-ωtt) between the target turning angular velocity ωtref and the turning angular velocity ωtt. An integral unit 924 integrates the difference (ωtref-ωtt) between the target turning angular velocity ωtref and the turning angular velocity ωtt and inputs a result of the integration to a subtraction unit 929 through addition.

The turning angular velocity ωtt is also output to a proportional unit 925. The proportional unit 925 performs proportional processing on the turning angular velocity ωtt and outputs a result of the proportional processing to the output restriction unit 926 as the motor current command value (first current command value) Imct0.

In the present embodiment, the output restriction unit 926 is a component configured to perform output restriction processing on the motor current command value (first current command value) Imct0 and output the motor current command value (second current command value) Imct. The output restriction unit 926 holds a current command value restriction characteristic for which a current restriction value is set in accordance with the turning motor angular velocity ωmct in advance.

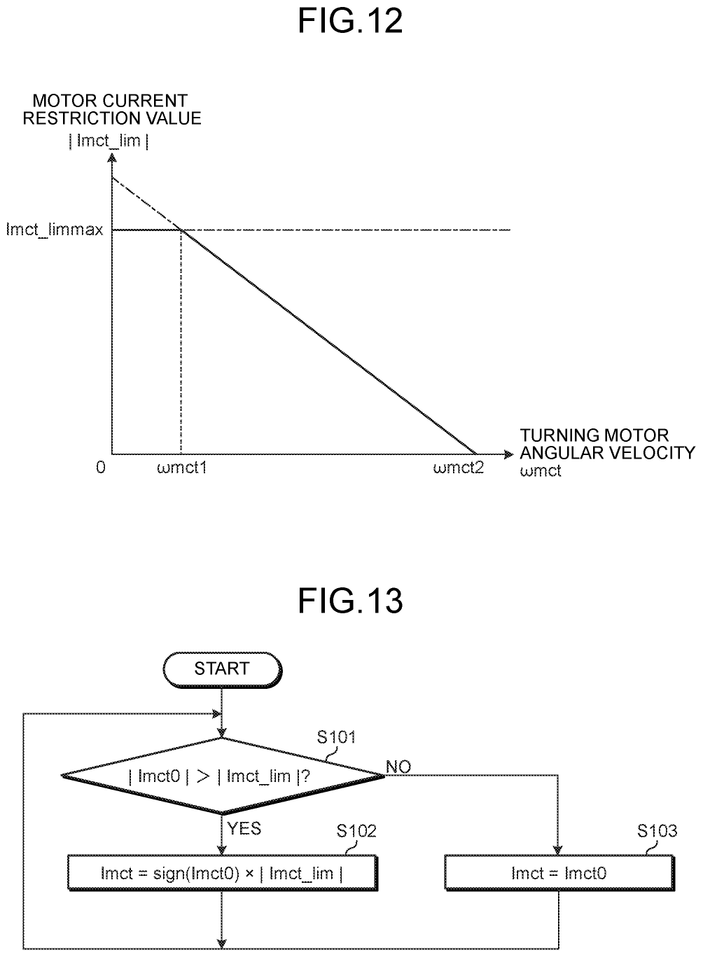

FIG. 12 is a diagram illustrating an exemplary current command value restriction characteristic according to the first embodiment. In FIG. 12, the horizontal axis represents the turning motor angular velocity ωmct, and the vertical axis represents a motor current restriction value Imct-lim.

As illustrated in FIG. 12, in the region of ωmct <ωmct1, the motor current restriction value |Imct_lim| is determined by maximum output current Imct_limmax of the current control unit 930. In the region of ωmct1 ≤ωmct ≤ωmct2, the motor current restriction value |Imct_lim| is determined by an output characteristic of the current control unit 930 in accordance with the turning motor angular velocity ωmct. Thus, the current command value restriction characteristic illustrated in FIG. 12 can be set offline based on the maximum output current Imct_immax and output characteristic: of the current control unit 930.

A specific example of the output restriction processing at the output restriction unit 926 will be described below with reference to 13. FIG. 13 is a flowchart illustrating exemplary output restriction processing at the output restriction unit.

The output restriction unit 926 compares the magnitude |Imct0| of the motor current command value (first current command value) Imct0 and the motor current restriction value |Imct_lim|. Specifically, the output restriction unit 926 determines whether the magnitude |Imct0| of the motor current command value (first current command value) Imct0 is larger than the motor current. restriction value |Imct_lim| (step S101).

When the magnitude |Imct0| of the motor current command value (first current command value) Imct0 is larger than the motor current restriction value |Imct_lim| (Yes at step S101), the output restriction unit 926 outputs, as the motor current command value (second current command value) Imct, a value obtained by multiplying the motor current restriction value |Imct_lim| by a sign function (sign(Imct0)) of the motor current command value (first current command value) Imct0 (step S102).

When the magnitude |Imct0| of the motor current command value (first current command value) Imct0 is equal to or smaller than the motor current restriction value |Imct_lim| at step S101), the output restriction unit 926 outputs the motor current command value (first current command value) Imct0 as the motor current command value (second current command value) Imct (step S103).

Through the processing illustrated in FIG. 13, the motor current command value (second current command value) Imct output from the output restriction unit 926 is restricted to the motor current restriction value |Imct_lim| when the magnitude Imct0 of the motor current command value (first current command value) Imct0 is larger than the motor current restriction value |Imct_lim| (Yes at step S101).

Note that, the configuration of the turning angle control unit 920 in the present embodiment is exemplary and may be different from the configuration illustrated in FIG. 11.

Motor current of the turning motor 71 is restricted by the output restriction unit 926 of the turning angle control unit 920, for example, when the driver performs abrupt steering or when the driver performs steering in a situation in which turning is difficult because, for example, the steering wheels 8L and 8R are in contact with a curb. In this case, the turning angle in accordance with the steering angle is not obtained due to the deviation between the steering angle and the turning angle, which potentially provides discomfort to the driver.

The target steering torque generation unit 200 according to the present embodiment includes the turning motor output characteristic correction unit 250 configured to calculate the torque signal Tref_t (second torque signal) by using an increasing function (Expression (9)) in accordance with the deviation (Imct0_Imct) between the motor current command value (first current command value) Imct0 derived based on the target turning angle θtref generated by the target turning angle generation unit 910 and the motor current command value (second current command value) Imct output from the output restriction unit 926 as illustrated in FIG. 4, and generates the target steering torque Tref by adding the torque signal Tref_t (second torque signal) output from the turning motor output characteristic correction unit 250 to the torque signal Tref_a (first torque signal) generated by using the basic map illustrated in FIG. 5.

Accordingly, the target steering torque Tref can be obtained in accordance with the deviation (Imct0-Imct) between the motor current command value (first current command value) Imct0 and the motor current command value (second current command value) Imct. Specifically, the torque signal Tref_t (second torque signal) added to the torque signal Tref_a (first torque signal) is larger as the deviation (Imct0-Imct) between the motor current command value (first current command value) Imct0 and the motor current command value (second current command value) Imct is larger.

As a result, the steering reaction force increases, thereby preventing the driver from performing abrupt steering and the driver from performing steering in a situation in which the steering wheels 8Land 8R are difficult to turn. Accordingly, the deviation between the steering angle and the turning angle is reduced, which can increase the following capability of the turning angle for the steering angle.

In this manner, with the vehicle steering device according to the present embodiment, it is possible to perform real-time control in accordance with the deviation (Imct0-Imct) between the motor current command value (first current command value) Imct0 and the motor current command value (second current command value) Imct, and thus it is possible to increase the following capability of the turning angle for the steering angle and reduce discomfort provided to the driver.

### Second Embodiment

The entire configuration of the vehicle steering device, the hardware configuration of the control unit, the individual configurations of the target steering torque generation unit, the twist angle control unit, the target turning angle generation unit, and the turning angle control unit, the current command value restriction characteristic, and the processing at the output restriction unit are identical to those in the first embodiment described above, and thus duplicate description thereof is omitted in the following description. Any component having a configuration same as that described above in the first embodiment is denoted by the same reference sign and duplicate description thereof is omitted.

In the present embodiment, the turning motor output characteristic correction unit 250 calculates the torque signal Tref_t by using an increasing function indicated by Expression (10) below based on the motor current command value (first current command value) Imct0 and the motor current command value (second current command value) Imct. Note that, “a” and “b” in Expression (10) below, are predetermined. coefficents.

Tref_t=a×(Imct0−Imct)³+b×(Imct0−Imct) (10)

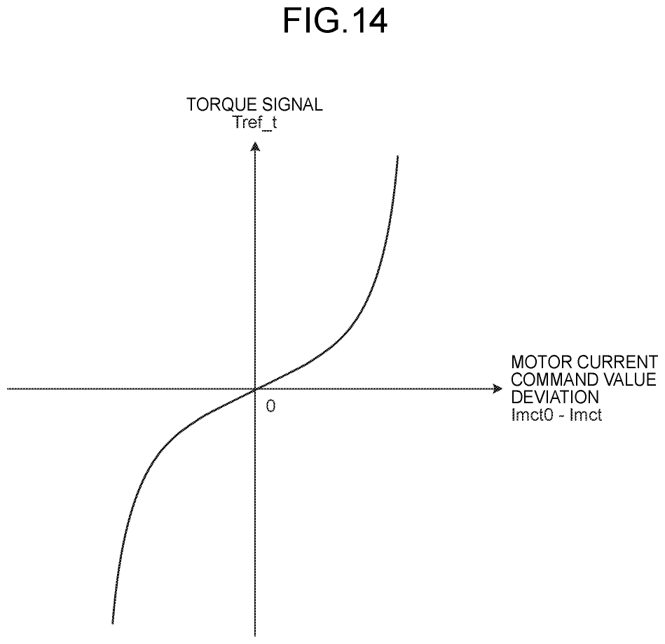

FIG. 14 is a diagram illustrating exemplary characteristics of the turning motor output characteristic correction unit according to a second embodiment. The exemplary characteristics illustrated in FIG. 14 are expressed as a two-dimensional graph of the increasing function indicated by Expression (10) above. In FIG. 14, the horizontal axis represents the motor current command value deviation Imct0_Imct, and the vertical axis represents the torque signal Tref_t. As illustrated in FIG. 14, the increasing function indicated by Expression (10) above is a cubic function that passes through the origin ((Imct0-Imct), Tref_t)=(0, 0) and has no extreme value.

The turning motor output characteristic correction unit 250 may hold. the exemplary characteristics illustrated in FIG. 14 as a map and calculate the torque signal Tref_t in a map referring manner.

For example, in a case of right steering, the torque signal Tref_t has a positive value when the deviation (Imct0-Imct) between the motor current command value (first current command value) Imct0 and the motor current command value (second current command value) Imct has a positive value, and the change rate of the torque signal Tref_t increases as the magnitude |Imct0-Imct| of the deviation (Imct0-Imct) between the motor current command value (first current command value) Imct0 and the motor current command value (second current command value) Imct increases.

In a case of left steering, the torque signal Tref_t has a negative value when the deviation (Imct0-Imct) between the motor current command value (first current command value) Imct0 and the motor current command value (second current command value) Imct has a negative value, and the change rate of the torque signal Tref_t increases as the magnitude |Imct0-Imct| of the deviation (Imct0-Imct) between the motor current command value (first current command value) Imct0 and the motor current command value (second current command value) Imct increases.

The value of the torque signal Tref_t is “0” when the deviation (Imct-Imct) between the motor current command value (first current command value) Imct0 and the motor current command value (second current command value) Imct is “0”, in other words, no output restriction is provided by the turning motor output characteristic correction unit 250.

When the torque signal Tref_t is calculated by using the increasing function indicated by Expression (10) above or the exemplary characteristics illustrated in FIG. 14, the steering reaction force can be further increased than in the first embodiment as the magnitude |Imct0-Imct| of the deviation (Imct0-Imct) between the motor current command value (first current command value) Imct0 and the motor current command value (second current command value) Imct increases. Accordingly, the deviation between the steering angle and the turning angle can further be reduced

### Third Embodiment

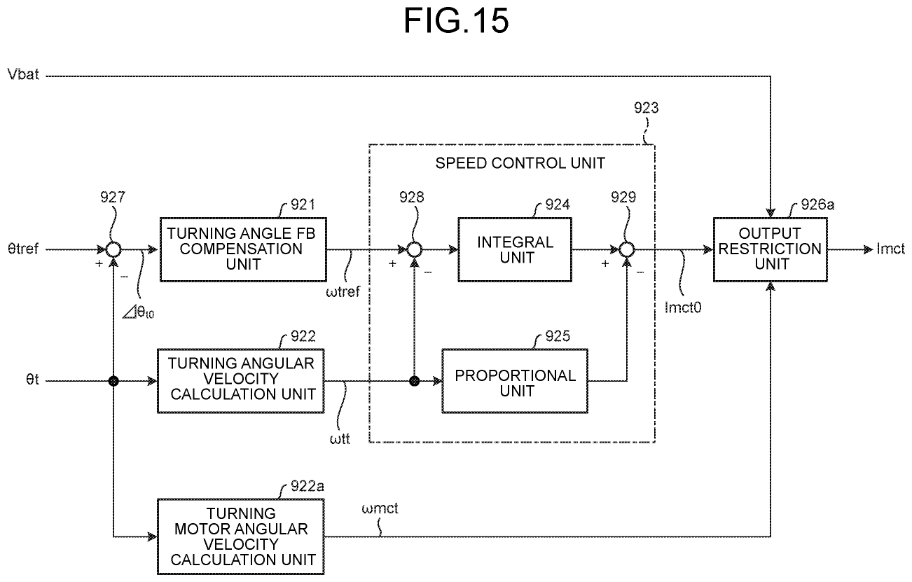

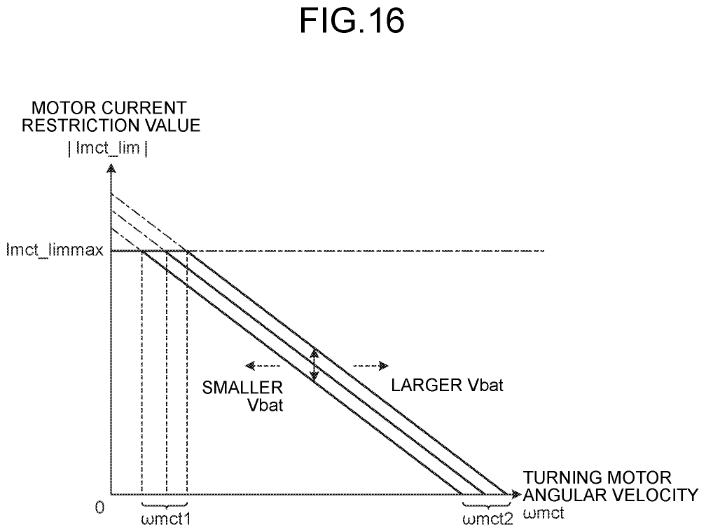

FIG. 15 is a block diagram. illustrating an exemplary configuration of the turning angle control unit according to a third embodiment. FIG. 16 is a diagram illustrating an exemplary current command value restriction characteristic according to the third embodiment. The entire configuration of the vehicle steering device, the hardware configuration of the control unit, the individual configurations of the target steering torque generation unit, the twist angle control unit, and the target turning angle generation unit, the characteristics of the turning motor output characteristic correction unit, and the processing at the output restriction unit are identical to those in the first embodiment or the second embodiment described above, and thus duplicate description thereof is omitted in the following description. Any component having a configuration same as that described above in the first embodiment or the second embodiment is denoted by the same reference sign and duplicate description thereof is omitted.

In the present embodiment, a voltage value Vbat of a drive power source of the turning motor 71 is input to an output restriction unit 926a. Alternatively, the output restriction unit 926a may have an aspect of detecting the voltage value Vbat of the drive power source of the turning motor 71. The drive power source of the turning motor 71 is supplied from, for example, the battery 13 (refer to FIG. 1).

Expression (11) below is given for the motor, where Vm represents motor application voltage, I represents motor current, R represents a motor resistance value, L represents a motor inductance value, di/dt represents motor current change, and e represents motor back electromotive force.

Vm=I×R+L×(di/dt)+e (11)

Expression (12) below is obtained when Expression (11) above is rewritten for the motor current I and the motor current change is ignored.

I=(Vm−e)/R (12)

When Expression (12) above is applied. to the turning motor 71 and the motor current I is set to be the current value imd of the turning motor 71, the motor application voltage Vm is proportional to the voltage value Vbat of the drive power source supplied to the control unit 50 and the motor back electromotive force e is proportional to the turning motor angular velocity ωmct. In other words, the change amount of the motor current restriction value |Imct_lim| corresponding to a predetermined angular velocity of the turning motor 71 is proportional to the change amount of the voltage value Vbat of the drive power source of the turning motor 71 in the region of ωmct1 ≤ωmct ≤ωmct2, in which the motor current restriction value |Imct_lim| is determined by the output characteristic of the current. control unit 930 in accordance with the turning motor angular velocity ωmct.

In the present embodiment, the output restriction unit 926a changes the current command value restriction characteristic in accordance with the level of the voltage value Vbat of the drive power source of the turning motor 71 as illustrated in FIG. 16. In other words, the output restriction unit 926a sets the motor current restriction value |Imct_lim| in accordance with the voltage value Vbat of the drive power source of the turning motor 71.

Specifically, the output. restriction unit 926a performs control so that the change amount of the motor current restriction value |imct_lim| becomes a value proportional to the change amount of the voltage value Vbat of the drive power source of the turning motor 71 at the predetermined angular velocity in the region of ωmct1 ≤ωmct ≤ωmct2, in which the motor current restriction value |Imct_lim| is determined by the output characteristic of the current control unit 930 in accordance with the turning motor angular velocity ωmct. As a result, at the predetermined angular velocity in the region of ωmct1 ≤ωcmct ≤ωmct2, the motor current restriction value |Imct_lim| increases as the voltage value Vbat increases, and the motor current restriction value |Imct_lim| decreases as the voltage value Vbat decreases. In other words, at the predetermined angular velocity in the region of ωmct1 ≤ωmct ≤ωmct2, the region of ωmct1 ≤ωmct ≤ωmct2 becomes higher as the voltage value Vbat increases, and the region of ωmct1 ≤ωmct ≤ωmct2 becomes lower as the voltage value Vbat decreases.

Accordingly, at the predetermined angular velocity in the region of ωmct1 ≤ωmct ≤ωmct2, the value (=sign(Imct0)×|Imct_lim|) of the motor current command value (second current command value) Imct when the magnitude |Imct0| of the motor current command value (first current command value) Imct0 is larger than the motor current restriction value |Imct_lim| increases as the voltage value Vbat increases, and decreases as the voltage value Vbat decreases.

In this manner, since the current command value restriction characteristic is changed in accordance with the level of the voltage value Vbat of the drive power source of the turning motor 71, the motor current supplied to the turning motor 71 can be appropriately restricted in accordance with the level of the voltage value Vbat. Since the motor current restriction value |mct_lim| is appropriately set in accordance with the level of the voltage value that of the drive power source of the turning motor 71, decrease of the voltage value Vbat due to, for example, aging of the battery 13 can also be handled.

Note that, although the above description is made on the example in which the motor current restriction value |Imct_lim| is set in accordance with the level of the voltage value Vbat of the drive power source of the turning motor 71, any aspect that can obtain the current command value restriction characteristic in accordance with the level of the voltage value Vbat may be employed. For example, an aspect may be employed in which a plurality of current command value restriction characteristics is set in accordance with the level of the voltage value Vbat.

Note that, the drawings used in the above description are conceptual diagrams for performing qualitative description of the present disclosure, and the present disclosure is not limited to these drawings. The above-described embodiments are preferable examples of the present disclosure, but not limited thereto, and may be modified in various manners without departing from the scope of the present disclosure.

### REFERENCE SIGNS LIST

1 wheel

2 column shaft

3 deceleration mechanism

5 pinion rack mechanism

6a, 6b tie rod

7a, 7b hub unit

8L, 8R steering wheel

10 torque sensor

11 ignition key

12 vehicle speed sensor

13 battery

14 rudder angle sensor

50 control unit (ECU)

60 reaction force device

61 reaction force motor

70 drive device

71 turning motor

72 gear

73 angle sensor

130 current control unit

140 motor current detector

200 target steering torque generation unit

210 basic map unit

211 multiplication unit

213 sign extraction unit

220 differential unit

230 damper gain map unit

240 hysteresis correction unit

250 turning motor output characteristic correction unit

260 multiplication unit

261, 262, 263 addition snit

300 twist angle control unit

310 twist angle feedback (FB) compensation unit

320 twist angular velocity calculation unit

330 speed control unit

331 integral unit

332 proportional unit

333, 334 subtraction unit

340 stabilization compensation unit

350 output restriction snit

361 subtraction unit

362 addition unit

500 conversion unit

910 target turning angle generation unit

920 turning angle control unit

921 turning angle feedback (FB) compensation unit

922 turning angular velocity calculation unit

922a turning motor angular velocity calculation unit

923 speed control unit

926, 926a output restriction unit

927 subtraction unit

930 current control unit

931 restriction unit

933 correction unit

932 rate restriction unit

940 motor current detector

1001 CPU

1005 interface

1006 A/D converter

1007 PWM controller

1100 control computer (MCU)

1. A vehicle steering device comprising:
a reaction force motor configured to apply steering reaction force to a wheel;
a turning motor configured to turn tires in accordance with steering of the wheel; and
a control unit configured to control the reaction force motor and the turning motor, wherein
the control unit includes
a target steering torque generation unit configured to generate target steering torque for the reaction force motor,
a target turning angle generation unit configured to generate a target turning angle for the turning motor,
a turning angle control unit configured to generate a first current command value of the turning motor based on the target turning angle and output a second current command value obtained by restricting the first current command value to a current restriction value in accordance with an angular velocity of the turning motor, and
a current control unit configured to drive the turning motor based on the second current command value, and
the target steering torque generation unit generates a first torque signal based on a predetermined basic map in accordance with at least a vehicle speed and a steering angle of a vehicle and generates the target steering torque by adding, to the first torque signal, a second torque signal in accordance with a deviation between the first current command value and the second current command value.

2. The vehicle steering device according to claim 1, wherein the second torque signal is provided by an increasing function in accordance with the deviation between the first current command value and the second current command value.

3. The vehicle steering device according to claim 2, wherein the increasing function is a linear function that passes through the origin of a two-dimensional graph having the deviation between the first current command value and the second current command value as a horizontal axis and having the second torque signal as a vertical axis.

4. The vehicle steering device according to claim 2, wherein the increasing function is a cubic function that passes through the origin of a two-dimensional graph having the deviation between the first current command value and the second current command value as a horizontal axis and having the second torque signal as a vertical axis, and has no extreme value.

5. The vehicle steering device according to claim 2, wherein the target steering torque generation unit calculates the second torque signal by using the increasing function.

6. The vehicle steering device according to claim 2, wherein the target steering torque generation unit holds a characteristic of the increasing function as a map and calculates the second torque signal with reference to the map.

7. The vehicle steering device according to claim 1, wherein the turning angle control unit
outputs the current restriction value as the second current command value when the first current command value is larger than the current restriction value, and
outputs the first current command value as the second current command value when the first current command value is equal to or smaller than the current restriction value.

8. The vehicle steering device according to claim 7, wherein the current restriction value is set in accordance with a voltage value of a drive power source of the turning motor.

9. The vehicle steering device according to claim 8, wherein the current restriction value corresponding to a predetermined angular velocity of the turning motor increases as the voltage value of the drive power source of the turning motor increases, and the current restriction value decreases as the voltage value of the drive power source of the turning motor decreases.

10. The vehicle steering device according to claim 8, wherein a change amount of the current restriction value corresponding to a predetermined angular velocity of the turning motor is proportional to a change amount of the voltage value of the drive power source of the turning motor.
